(19) United States
(12) Patent Application Publication
(10) Pub. No.: US 2019/0132345 A1
(43) Pub. Date: May 2, 2019

(54) APPARATUS FOR NETWORK FUNCTION VIRTUALIZATION USING SOFTWARE DEFINED NETWORKING AND OPERATION METHOD THEREOF

(71) Applicant: Atto Research Co., Ltd., Seongnam (KR)

(72) Inventors: Eun Ho CHA, Seoul (KR); Tae Kyung LEE, Suwon (KR); Yong Joo SONG, Seongnam (KR)

(21) Appl. No.: 16/167,115

(22) Filed: Oct. 22, 2018

(30) Foreign Application Priority Data
Oct. 27, 2017 (KR) 10-2017-0140762

(51) Int. Cl. H04L 29/06; H04L 12/26

(52) U.S. Cl. CPC H04L 63/1425; H04L 43/062

(57) ABSTRACT

A network function virtualization (NFV) apparatus according to the present disclosure may include: a virtual machine which is configured to perform a first network function, generate a flow rule according to network configuration information received from a user or a result of performing the first network function, and transmit the flow rule to a software switch; and the software switch which is configured to perform a second network function, and process a packet according to the flow rule. According to the present disclosure, separate a virtual network function may be separated into a data (packet) processing function and a control function, whereby a fast processing speed provided by a software switch and virtual machine's processing capability with high complexity may be maximally utilized.

### BACKGROUND OF THE INVENTION

### 1. Field of the Invention

The present disclosure relates to a network function virtualization (NFV) apparatus that uses software-defined networking, and an operation method thereof. More particularly, the present disclosure relates to a method in which an NFV apparatus implements an NFV apparatus with improved performance by combining a virtual network function (VN) implemented via a virtual machine and a virtual network function implemented using software-defined networking, and an apparatus thereof.

### 2. Description of the Prior Art

Recently, network function virtualization technology has caused changes across the network architecture which has been mainly associated with hardware. Network function virtualization (NFV) is a concept that separates hardware and software which are components of a network, virtualizes the functions of physical network equipment, and executes the virtualized functions by a virtual machine (VM) server, hardware with a general processor, and a cloud computer.

According to the concept, various network equipment such as a router, a load balancer, a firewall, intrusion prevention equipment, a virtual private network, or the like may be implemented in a general server, using software, whereby users may be independent from a vender in the network configuration. Furthermore, expensive dedicated equipment may be replaced with general hardware and dedicated software. In addition, there are many advantages, for example, the cost of operating equipments may be reduced, a change in traffic may be quickly handled, or the like.

Software-defined networking, that is, SDN technology, can separate the complex function of a control plane from a data plane. According to the SDN, the complex function of the control plane is processed by software, and the data plane performs only a simple function directed by the control plane, such as network packet transmission, disregard, change, or the like.

By applying the above-described technology, a new network function has been developed using software without limitation by complex hardware, and various attempts may be allowed, which were not allowed in an existing network structure.

The NFV and the SDN are different technologies but they can be complementarily applied to each other. Various network functions, which are implemented by software according to the NFV, may be efficiently controlled using the SDN.

When an NFV apparatus is implemented as a single physical server, an NFV apparatus 10 as shown in FIG. 1 may include at least one virtual machine 31, 33, and 35 that provides a virtual network function, a software switch 50, and ports 13 and 15 that connect a physical network with another server.

The software switch 50 may act as a virtual network hub that connects an external physical network with virtual machines operating in the installed server. The virtual machines 31, 33, and 35 may perform functions which have been provided by an existing hardware-based network equipment, such as load balancing, a virtual private network, a firewall, an intrusion prevention function, and the like.

In this instance, every time that a packet is input into and output from a virtual machine, overhead attributable to capsulation or decapsulation may occur in the virtual machine, which may be a load of operating a network. A virtual network function modeled and applied to the software switch 50 may operate with smaller overhead than a virtual network function modeled and applied to a virtual machine, but the virtual network function modeled and applied to the software switch is significantly limited and may provide only a tap function or a simple firewall function.

Therefore, there is a desire for a method for improving a problem occurring in each module, and maximizing the function of each module.

### SUMMARY OF THE INVENTION

The present disclosure has been made in order to solve the above-mentioned problems in the prior art and an aspect of the present disclosure is to provide a network function virtualization (NFC) apparatus that separates the work of a virtualization network function (VNF) into a data (packet) processing function and a control function, and maximally utilizes a fast processing speed provided by a software switch and virtual machine's processing capability with high complexity.

Another aspect of the present disclosure is to separate the work of a VNF into a data processing function and a control function, whereby a physical server and a physical switch provide a control function and a data processing function, respectively.

In accordance with an aspect of the present disclosure, there is provided an operation method of a network function virtualization (NFV) apparatus including a virtual machine and a software switch, the operation method including: operation a in which the virtual machine performs a first network function; operation b in which the software switch performs a second network function; operation c in which the virtual machine transmits, to the software switch, a flow rule that is based on network configuration information received from a user or a result of performing the first network function; and operation d in which the software switch processes a packet according to the flow rule.

In accordance with an aspect of the present disclosure, there is provided a network function virtualization (NFV) apparatus, the NFV apparatus including: a virtual machine which is configured to perform a first network function, to generate a flow rule according to network configuration information received from a user or a result of performing the first network function, and to transmit the flow rule to a software switch; and the software switch which is configured to perform a second network function, and to process a packet according to the flow rule.

According to the present disclosure, there is provided an NFV apparatus that may separate a virtual network function into a data (packet) processing function and a control function, thereby maximally utilizing a fast processing speed provided by a software switch and virtual machine's processing capability with high complexity.

Also, according to the present disclosure, a virtual network function is separated into a data processing function and a control function, whereby a physical server and a physical switch provide a control function and a data processing function, respectively. Accordingly, high-performance packet processing that utilizes a hardware chip may be performed and the network configuration of a physical server may be simplified.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating the conventional network function virtualization apparatus;

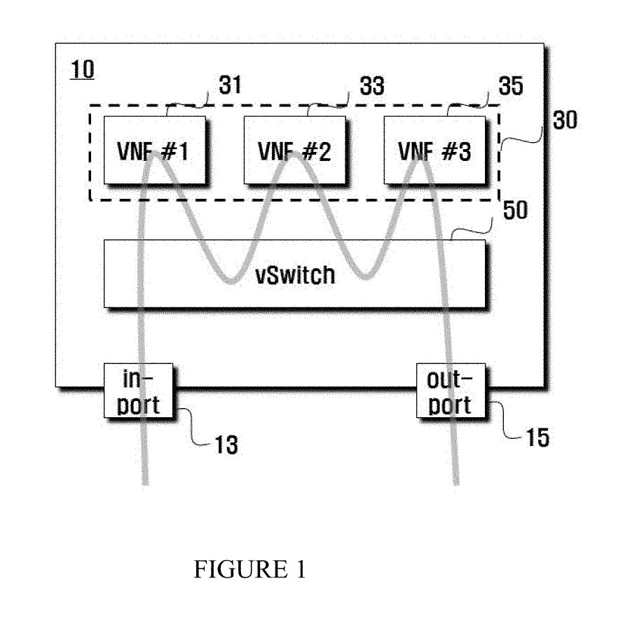

FIG. 2 is a diagram illustrating a network function virtualization apparatus according to an embodiment of the present disclosure;

FIG. 3 is a diagram illustrating the conventional server-switch hardware;

FIG. 4 is a diagram illustrating an example in which a network function virtualization apparatus is implemented in a server-switch hardware, according to an embodiment of the present disclosure;

FIG. 5 is a flowchart illustrating an operation method of a network function virtualization apparatus according to an embodiment of the present disclosure;

FIG. 6 is a flowchart illustrating an operation method of a network function virtualization apparatus, which acts as a load balancer, according to an embodiment of the present disclosure; and

FIG. 7 is a flowchart illustrating an operation method of a network function virtualization apparatus, which performs an IDS function and an IPS function according to an embodiment of the present disclosure.

### DETAILED DESCRIPTION OF THE EXEMPLARY EMBODIMENTS

The above-described aspects, features, and advantages will be described with reference to enclosed drawings. Accordingly, those skilled in the art may easily implement the technical ideal of the present disclosure. When detailed descriptions associated with a well-known related art are determined to make the subject matter of the present disclosure ambiguous, the detailed descriptions will be omitted herein. Hereinafter, exemplary embodiments according to the present disclosure will be described in detail with reference to enclosed drawings. The same reference numerals in the drawings denote the same or like elements. All combinations described in the specification and the scope of the claims may be combined based on a random method. The singular forms are intended to include the plural forms as well, unless the context clearly indicates otherwise.

Hereinafter, an NFV apparatus and an operation method thereof according to an embodiment of the present disclosure will be described with reference to attached drawings.

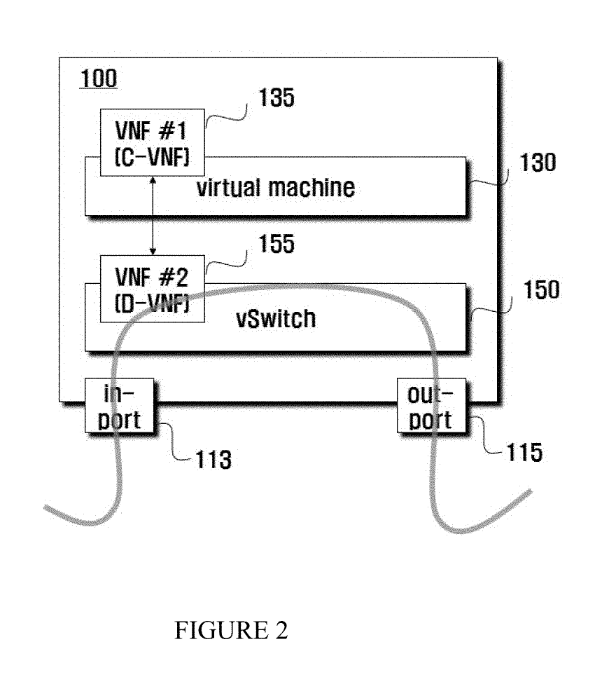

FIG. 2 is a diagram illustrating the configuration of an NFV apparatus according to an embodiment of the present disclosure. Referring to FIG. 2, an NFV apparatus 100 according to an embodiment of the present disclosure may include a virtual machine 130, a software switch 150, and ports 113 and 115.

The virtual machine 130 may perform a first network function, may generate a flow rule based on network configuration information received from a user or a result of performing the first network function, and may transmit the flow rule to a software switch.

A C-VNF 135 is a virtual network function (VNF) which is modeled and applied to the virtual machine, and performs a network function including the first network function. The C-VNF 135 may perform a function of communicating with a user on the virtual machine, a function of providing information to a user, and a function of generating a flow rule for controlling the software switch 150 and transmitting the flow rule to the software switch 150.

The C-VNF 135 is named “C-VNF 135” in the meaning of a virtual network function (VNF) that is in charge of a control plane. However, the C-VNF 135 operates on the virtual machine and thus, it may be understood that the C-VNF 135 and the virtual machine 130 described in the present specification are substantially the same. Hereinafter, therefore, the C-VNF 135 will be described as the virtual machine 130.

The virtual machine 130 performs the first network function, such as adding or deleting a host to be managed to/from a virtual network function, checking the states of hosts to be managed, or the like, wherein the first network function requires relatively higher complexity than a second network function performed by the software switch 150.

A D-VNF 155 is a virtual network function (VNF) modeled and applied to the software switch 150, and performs packet processing or the like which requires quick processing. In the same manner, the D-VNF 155 operates in the software switch 150 and thus, it may be understood that the D-VNF 155 and the software switch 150 described in the present specification are the substantially the same. Hereinafter, therefore, the D-VNF 155 will be described as the software switch 150 that performs the second network function.

The software switch 150 is a module that performs packet processing which requires quick processing, and indicates a kind of a virtual switch that supports a software-defined networking protocol, such as an OpenFlow protocol, a NetConf protocol, an open V switch database (OVSDB), or the like.

The software switch 150 performs the second network function, and may process a packet according to a flow rule provided by the virtual machine 130. It is understood that the term “flow rule” in the specification of the present disclosure indicates a network policy that the virtual machine 130 creates and applies in the software-defined networking. In addition, it is understood that the flow rule indicates a flow entry according to the network policy, with respect to the software switch 150.

The software switch 150 according to an embodiment of the present disclosure may perform or assist to perform a function of preventing an intrusion, a function of load balancing, or the like according to a flow rule received from the virtual machine 130, in addition to performing a tap function or a simple firewall function.

The virtual machine 130 may provide a user interface, and may communicate with a user via the user interface. The virtual machine 130 may receive network configuration information from a user, wherein the network configuration information may include identification information of one or more hosts to be managed and network function configuration information. The network function configuration information may indicate information associated with a network function that the NFV apparatus 100 is to perform, and information associated with a virtual network function that is to be modeled and applied to the virtual machine 130. The network configuration information indicates configuration information that is required when the NFV apparatus performs the network function.
When the NFV Apparatus is Used as a Load Balancer

For example, when a user desires to use the NFV apparatus 100 as a load balancer, the virtual machine 130 may receive, via a user interface, network function configuration information that configures the NFV apparatus 100 as a load balancer. Also, the virtual machine 130 may receive an IP, a port, identification information of hosts to be managed, information associated with whether the state of a host to be managed is checked, a packet distribution method, grouping information associated with hosts to be managed, or the like from a user via the network configuration information, as information required to perform load balancing.

When configuration is completed based on the network configuration information received from the user, the virtual machine 130 may generate a flow rule using the same, and may transmit the flow rule to the software switch 150 so as to implement the D-VNF 155 on the software switch 150.

The virtual machine 130 may check the states of one or more hosts to be managed at predetermined intervals, and when the result of the check shows that the state of a first host is changed, the virtual machine 130 may generate a flow rule that is based on the change in the state of the first host, and may transmit the generated flow rule to the software switch 150.

The virtual machine 130 may provide statistic information and state information of hosts to be managed to the user, and may request the user to change the setting. When the state of the first host is changed by a request from the user, as well as when a change is identified based on a periodical state check (health check), the virtual machine 130 may generate a flow rule according to the change in the state, and may transmit the same to the software switch 150.

The software switch 150 may distribute a packet to a host to be managed, according to the flow rule received from the virtual machine 130. The flow rule is generated based on the network configuration information transmitted by the user and thus, the distributed packet processing that the software switch 150 performs is based on the user setting.

For example, the software switch 150 may divide a departure logical address area and may perform distribution based on divided areas, or may group hosts to be managed and may distributively transmit packets for each group. The content of a packet is processed only in the D-VNF 155 on the software switch 150, and may not be transmitted to the C-VNF 135 of the virtual machine 130.
When the NFV Apparatus is Used as an Intrusion Detection System and an Intrusion Prevention System

The intrusion detection system (IDS) is a system that monitors events occurring in a computer or a network, detects whether an intrusion occurs, and copes with the results of monitoring and detection. The IDS is a structure that checks traffic using a TAP which is equipment that copies the original traffic without loss or modulation. That is, the IDS detects whether an intrusion occurs according to an out-of-path scheme, without being involved in the distribution of traffic.

The intrusion prevention system (IPS) is an active security solution for preventing an intrusion in real time before the intrusion occurs, and for blocking harmful traffic. The IPS is a technology that takes a preventive step in advance. Traffic uses an In-line scheme that allows distribution only after passing through the IPS and thus, the IPS is necessarily involved in the distribution of traffic and may deteriorate the performance of a network.

According to an embodiment of the present disclosure, a control may be performed such that the NFV apparatus 100 performs both the IDS function and the IPS function. For example, normally, the virtual machine 130 operates as an intrusion detection system, and the software switch 150 operates as a tap that copies a packet input to the NFV apparatus 100 and transmits the copied packet to the virtual machine 130. That is, the NFV apparatus 100 may copy a packet input to an in-port and may transmit the copied packet to the virtual machine 130, and may also output the copied packet to an output-port in parallel.

When it is determined that an attack occurs based on a result of performing an intrusion detection function, the virtual machine 130 transmits a first flow rule that blocks a session corresponding to the attack to the software switch 150. When the first flow rule is received, the software switch 150 may block the session using the first flow rule. According to the present disclosure, the NFV apparatus may operate as an IPS without deterioration in the performance of the network.
Application to Server-Switch Hardware

A network function virtualization method according to an embodiment of the present disclosure may separate a control function and a packet processing function and enable the functions to be performed in separate modules. That may also be applied to a server-switch hardware which is configured with a physical server and a physical switch.

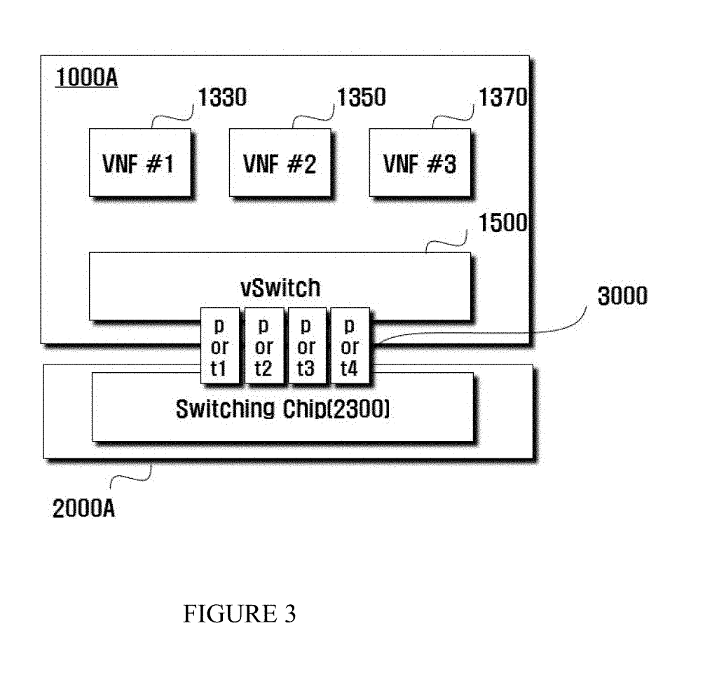

FIG. 3 is a diagram illustrating the conventional server-switch hardware. Referring to FIG. 3, a normal server-switch hardware includes a server module 1000A and a switch module 2000A. A x86 server is normally used as the server module 1000A. The server module 1000A contains a powerful CPU. Mostly, LINUX is contained. The server module 1000A may include virtual machines 1330, 1350 and 1370, and a software switch 1500.

The switch module 2000A includes a switching chipset, and uses, for chipset control, a CPU which shows relatively poor performance compared to that of the server module 1000A such as an Atom CPU. The switch module 2000A included in the server-switch hardware normally operates as an L2 switch, and includes a communication port 3000 to communicate with the server module 1000A.

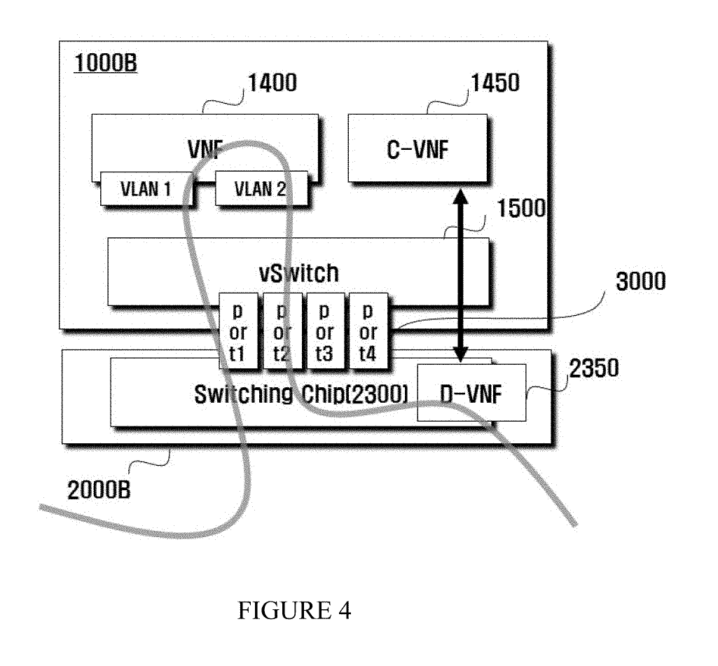

FIG. 4 is a diagram illustrating an example in which a network function virtualization apparatus is implemented in a server-switch hardware, according to an embodiment of the present disclosure. In the server-switch hardware, a virtual machine 1450 that performs a virtual network function (C-VNF) according to an embodiment of the present disclosure may be included in the server module 1000B, and a virtual network function (D-VNF) according to an embodiment of the present disclosure may be modeled and applied to a switching chip 2300 of the switch module 2000B.

In the server-switch hardware, the high performance of a hardware chip may be utilized by applying a virtual network function (D-VNF) that is in charge of a data plane to the switching chip, instead of, to the software switch 1500. Also, in this instance, the configuration of the server module 1000B is significantly simple, which is an advantageous.

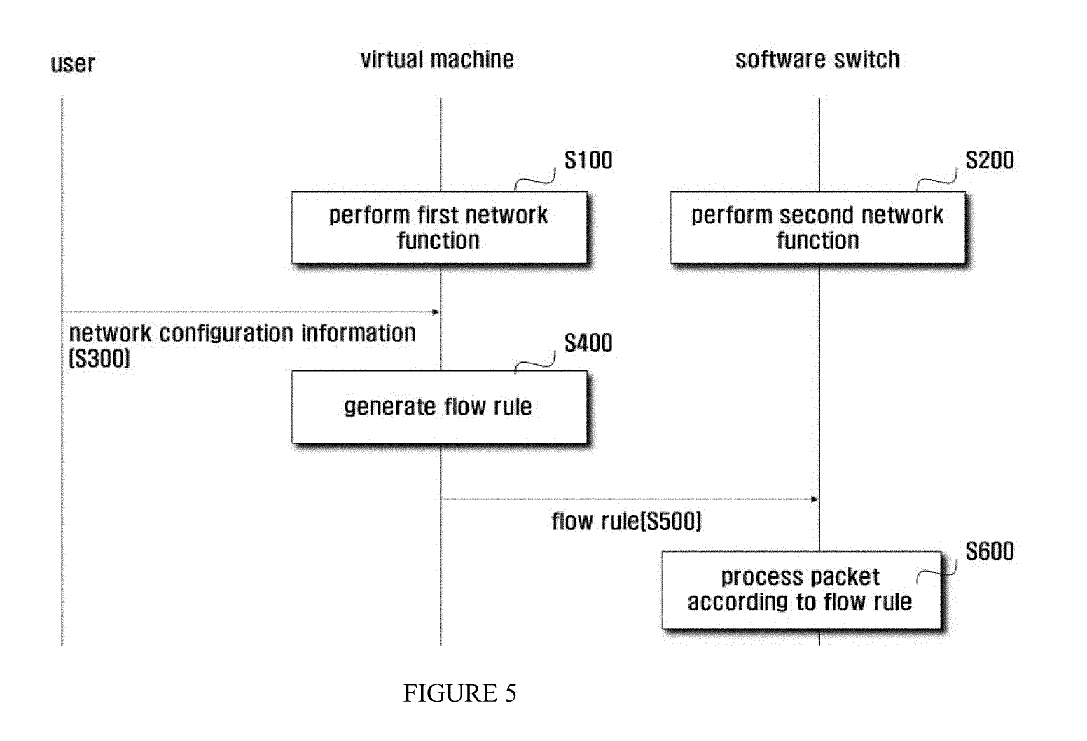

Hereinafter, an operation method of a network function virtualization apparatus according to an embodiment of the present disclosure will be described with reference to FIGS. 5 to 7. Some embodiments that overlap the descriptions that have been provided in association with the network function virtualization apparatus will be omitted. For reference, the operation method of the network function virtualization apparatus according to an embodiment of the present disclosure may not be limited by the order of symbols a, b, c, and the like which are used to distinguish operations. Also, the operation method may not be limited by the order of the reference numerals S100, S200, and the like used to indicate operations.

FIG. 5 is a flowchart illustrating an operation method of a network function virtualization apparatus according to an embodiment of the present disclosure. Referring to FIG. 5, a virtual machine performs a first network function in operation S100, and a software switch performs a second network function in operation S200. When the virtual machine receives network configuration information from a user in operation S300, the virtual machine may generate a flow rule using the received network configuration information or a result of performing the first network function in operation S400. The generated flow rule may be transmitted to the software switch in operation S500. In operation S600, the software switch that receives the flow rule processes a packet according to the flow rule.

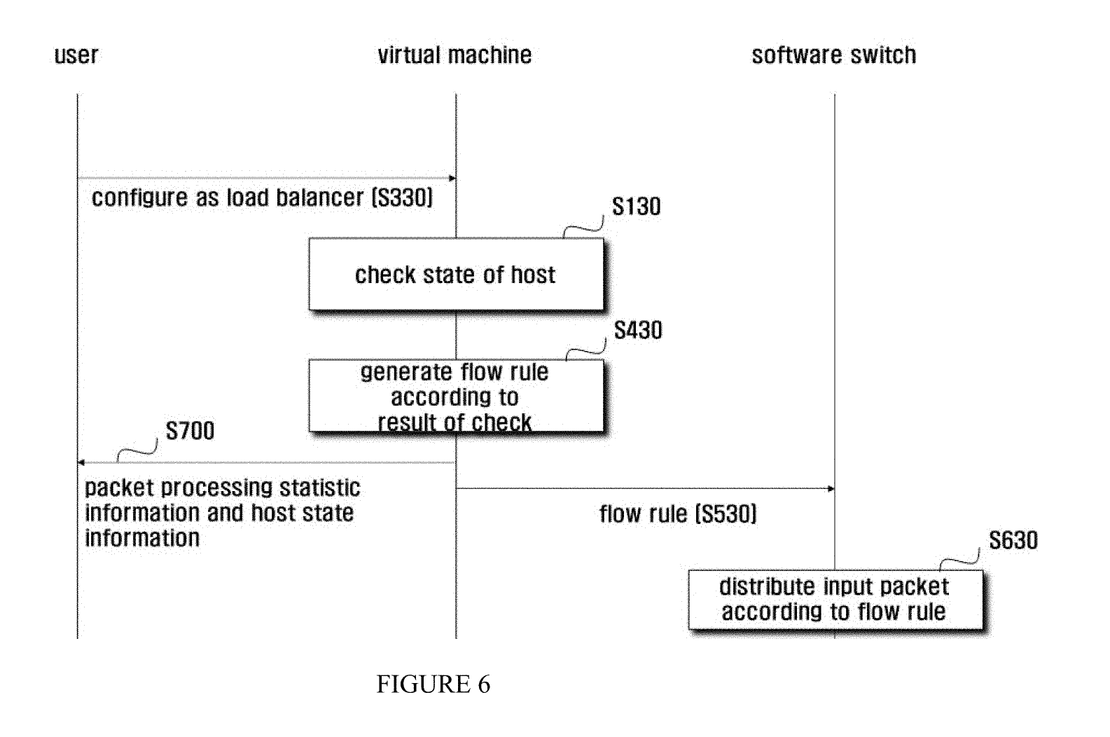

FIG. 6 is a flowchart illustrating an operation method of a network function virtualization apparatus which acts as a load balancer according to an embodiment of the present disclosure.

The network configuration information received from the user in operation S300 may include at least one piece of information from among identification information of one or more hosts to be managed and network function configuration information. FIG. 6 is an example of the case in which the network function configuration information corresponds to a load balancer.

When a user desires to use an NFV as a load balancer, network function configuration information that configures the NFV as a load balancer may be received in operation S330. In operation S330, the virtual machine may receive network configuration information including information for identifying a host to be managed, a traffic distribution method, or the like, as well as the network function configuration information.

The virtual machine may check the state of a host at predetermined intervals using the network configuration information in operation S130. When a result of the check in operation S130 shows that the state of a first host is changed, the virtual machine generates a flow rule that is based on the change in the state of the first host in operation S430, and transmits the flow rule to the software switch in operation S530. In addition, the virtual machine may provide statistic information associated with packet processing and state information of a host to be managed to the user in operation S700.

Although not illustrated, as another example, the virtual machine may generate a flow rule that changes the state of a second host in response to a request from the user in operation 430, and may transmit the content associated with the change of the state to the software switch in operation S530.

The software switch that receives the flow rule may distribute a packet to a host to be managed, according to the flow rule.

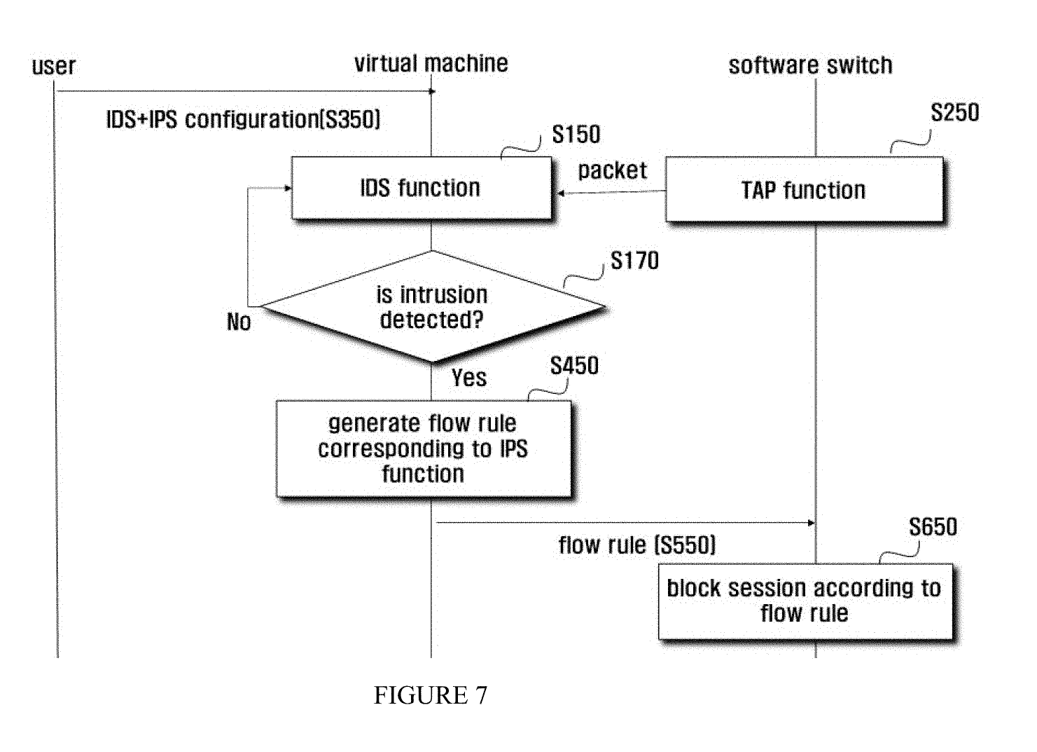

FIG. 7 is a flowchart illustrating an operation method of a network function virtualization apparatus which performs an IDS function and an IPS function according to an embodiment of the present disclosure.

Referring to FIG. 7, a user may transmit, to a virtual machine, network function configuration information for configuring an NFV to perform an IDS function and an IPS function in operation S350. The transmission may be performed via a user interface provided by the virtual machine.

According to the configuration, the virtual machine may perform a control such that a software switch performs a tap function that copies a packet input to an NFV apparatus and transmits the same to the virtual machine. The virtual machine may perform an intrusion detection function (IDS). When a result of performing the IDS shows that an attack occurs, the virtual machine generates a first flow rule that blocks a session corresponding to the attack in operation S450, and transmits the same to the software switch in operation S550. When the first flow rule is received, the software switch that receives the first flow rule blocks the session according to the first flow rule in operation S650, whereby the NFV also operates as the IPS.

The above-described disclosure combines a virtual network function performed using a virtual machine and a virtual network function performed using software-defined networking, whereby the network function virtualization apparatus quickly performs a complex function.

Some embodiments omitted in the present specification may be equally applied when subjects that implement the embodiments are the same. Also, the present disclosure, which has been described above, can be replaced, modified, and changed by those skilled in the art within a scope without departing from the spirit of the present disclosure, and thus, may not be limited to the above described embodiments and the attached drawings.

What is claimed is:

1. An operation method of a network function virtualization (NFV) apparatus including a virtual machine and a software switch, the operation method comprising:
operation a in which the virtual machine performs a first network function;
operation b in which the software switch performs a second network function;
operation c in which the virtual machine transmits, to the software switch, a flow rule that is based on network configuration information received from a user or a result of performing the first network function; and
operation d in which the software switch processes a packet according to the flow rule.

2. The operation method of claim 1, wherein the network configuration information comprises at least one piece of information from among identification information of one or more hosts to be managed and network function configuration information;
the operation a comprises an operation in which the virtual machine checks states of the hosts at predetermined intervals;
the operation c comprises an operation in which the virtual machine transmits, to the software switch, a flow rule that is based on a change in the state of a first host when a result of the check shows that the state of the first host is changed; and
the operation d comprises an operation in which the software switch distributes a packet to the host to be managed, according to the flow rule.

3. The operation method of claim 2, further comprising an operation in which the virtual machine provides, to the user, statistic information associated with packet processing and state information of the host to be managed.

4. The operation method of claim 1, wherein the operation a comprises an operation in which the virtual machine performs an intrusion detection function (intrusion detection system (IDS)),
the operation b comprises an operation in which the software switch performs a tap function that copies a packet input to the NFV apparatus and transmits the copied packet to the virtual machine,
the operation c comprises an operation in which, when a result of performing the intrusion detection function shows that an attack occurs, the virtual machine transmits a first flow rule that block a session corresponding to the attack to the software switch, and
the operation d comprises an operation in which the software switch blocks the session according to the first flow rule when the first flow rule is received.

5. A network function virtualization (NFV) apparatus, the NFV apparatus comprising:
a virtual machine configured to perform a first network function, generate a flow rule according to network configuration information received from a user or a result of performing the first network function, and transmit the flow rule to a software switch; and
the software switch configured to perform a second network function, and process a packet according to the flow rule.

6. The NFV apparatus of claim 5, wherein the network configuration information comprises identification information of one or more hosts to be managed and network function configuration information,
the virtual machine checks states of the hosts to be managed at predetermined intervals, and when a result of the check shows that a state of a first host is changed, transmits a flow rule that is based on a change in the state of the first host to the software switch, and
the software switch distributes a packet to the host to be managed, according to the flow rule.

7. The NFV apparatus of claim 6, wherein the virtual machine provides, to the user, statistic information associated with packet processing and state information of the host to be managed.

8. The NFV apparatus of claim 5, wherein the first network function includes an intrusion detection function,
when a result of performing the intrusion detection function shows that an attack occurs, the virtual machine transmits, to the software switch, a first flow rule that blocks a session corresponding to the attack,
the second network function includes a tap function that copies a packet input to the NFV apparatus and transmits the copied packet to the virtual machine, and
the software switch blocks the session when the first flow rule is received.

9. The NFV apparatus of claim 5, wherein the virtual machine is implemented in a physical server, and the software switch is implemented in a switching chip of a physical switch.
